(19) United States
(12) Patent Application Publication
(10) Pub. No.: US 2021/0149407 A1
(43) Pub. Date: May 20, 2021

(54) AUTONOMOUS VEHICLE ACCIDENT CONDITION MONITOR

(71) Applicant: International Business Machines Corporation, Armonk, NY (US)

(72) Inventors: Janani Janakiraman, Austin, TX (US); Fang Lu, Billerica, MA (US); Nadiya Kochura, Bolton, MA (US); Su Liu, Austin, TX (US)

(21) Appl. No.: 16/685,509

(22) Filed: Nov. 15, 2019

(51) Int. Cl. G05D 1/02; G06N 20/00; G05D 1/00

(52) U.S. Cl. CPC G05D 1/0221; G06N 20/00; G05D 2201/0213; G05D 1/0214; G05D 1/0088

(57) ABSTRACT

A method can include obtaining vehicle data corresponding to an autonomous vehicle. The autonomous vehicle can include a vehicle controller configured to control a set of driving maneuvers of the autonomous vehicle. The method can further include obtaining accident condition data based, at least in part, on the vehicle data. The accident condition data can include a first set of driving conditions under which a vehicle accident occurred. The method can further include generating an accident condition record based, at least in part, on the accident condition data. The method can further include determining that the vehicle controller is not trained to control the set of driving maneuvers of the autonomous vehicle under the first set of driving conditions. The method can further include generating, in response to the determining, a pending test case based, at least in part, on the accident condition record.

### BACKGROUND

The present disclosure relates to autonomous vehicles, and more specifically, to autonomous vehicle navigation control.

Autonomous vehicles can be trained to navigate roadways without manual control by a human driver. Such training can include testing an autonomous vehicle controller under a variety of driving conditions. The autonomous vehicle controller can make decisions about the operation of the autonomous vehicle according to a confidence value.

### SUMMARY

According to embodiments of the present disclosure, a method can include obtaining vehicle data corresponding to an autonomous vehicle. The autonomous vehicle can include a vehicle controller configured to control a set of driving maneuvers of the autonomous vehicle. The method can further include obtaining accident condition data. The accident condition data can be based, at least in part, on the vehicle data. The accident condition data can include a first set of driving conditions under which a vehicle accident occurred. The method can further include generating an accident condition record. The accident condition record can be based, at least in part, on the accident condition data. The method can further include determining that the vehicle controller is not trained to control the set of driving maneuvers of the autonomous vehicle under the first set of driving conditions. The method can further include generating, in response to the determining, a pending test case based, at least in part, on the accident condition record.

A system and a computer program product corresponding to the above method are also included herein.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts an example computing environment having an accident condition monitor, in accordance with embodiments of the present disclosure.

FIG. 2 depicts a flowchart of an example method for generating a set of pending test cases and a test coverage score, in accordance with embodiments of the present disclosure.

FIG. 3 depicts an example table that includes an accident condition record and example tables that include test case data, in accordance with embodiments of the present disclosure.

FIG. 4 depicts the representative major components of a computer system that can be used in accordance with embodiments of the present disclosure.

FIG. 5 depicts a cloud computing environment according to embodiments of the present disclosure.

FIG. 6 depicts abstraction model layers according to embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to autonomous vehicles; more particular aspects relate to an autonomous vehicle accident condition monitor. While the present disclosure is not necessarily limited to such applications, various aspects of the disclosure may be appreciated through a discussion of various examples using this context.

An autonomous vehicle controller (“vehicle controller”) can include a self-learning cognitive algorithm that can make decisions about the operation of an autonomous vehicle. Such decisions can be based, at least in part, on a calculated confidence value that corresponds to a set of driving conditions. (In this disclosure, a “set” can include one or more items; thus, a “set” of driving conditions can include one or more driving conditions). The calculated confidence value can indicate the vehicle controller's preparedness for maneuvering the autonomous vehicle under a set of driving conditions. For example, a vehicle controller can choose to maintain control of an autonomous vehicle as the autonomous vehicle approaches a construction zone if the calculated confidence value exceeds a threshold. In contrast, the vehicle controller can choose to relinquish control of the autonomous vehicle to another entity, e.g., a human driver, as the autonomous vehicle approaches heavy rain if the calculated confidence value does not exceed the threshold. The magnitude of the calculated confidence value can correspond to the vehicle controller's training under a set of driving conditions. Continuing with the example above, the vehicle controller may have been trained to maneuver the vehicle through the construction zone, but may not have been trained to maneuver the vehicle through the heavy rain environment; thus, the calculated confidence value may be greater for the construction zone scenario than for the heavy rain scenario. Training a vehicle controller can present challenges due to an extensive set of driving conditions an autonomous vehicle can encounter. For example, a set of driving conditions can include an array of road characteristics (e.g., road geometry, road type, and road conditions), weather information (e.g., precipitation, wind parameters, and temperature), and local parameters, such as traffic density and pedestrian density.

To address these and other problems, embodiments of the present disclosure include an accident condition monitor that can generate a set of pending test cases (e.g., a set of driving conditions under which a vehicle controller has not yet been trained) based, at least in part, on obtained accident condition data (e.g., data that specifies conditions under which one or more vehicle accidents have occurred). Embodiments of the present disclosure can further generate a test coverage score that indicates the extent to which the vehicle controller has been trained to handle one or more accident conditions (e.g., driving conditions that correspond to the vehicle accident, such as heavy rain, strong wind, low visibility, highway, dense traffic) identified within the obtained accident condition data. For example, in some embodiments, if accident condition data includes four accident conditions: (1) a curvy road, (2) strong winds, (3) heavy rain, and (4) nighttime driving, a vehicle controller trained to maneuver the autonomous vehicle under the combination of the four accident conditions can have a 100% test coverage score; whereas, a vehicle controller trained to maneuver the autonomous vehicle under a combination of three of the four accident conditions can have a 75% test coverage score. Embodiments of the present disclosure can further combine the test coverage score with a calculated confidence value, such that operational decisions made by the vehicle controller can be based, at least in part, on the test coverage score and the calculated confidence value.

By generating a set of pending test cases from accident condition data, embodiments of the present disclosure can identify potentially hazardous driving conditions that can affect a specific driving environment, such as a specific geographic location, intersection, construction zone, etc. Accordingly, embodiments of the present disclosure can facilitate effective testing of vehicle controllers, such that they can be trained to operate under specific driving conditions that have resulted in vehicle accidents. Additionally, by generating a test coverage score, embodiments of the present disclosure can permit the vehicle controller to make operational decisions (e.g., whether to maintain or relinquish control of the autonomous vehicle) based on whether the vehicle controller has been tested under conditions that have resulted in vehicle accidents. Accordingly, embodiments of the present disclosure can improve the safe operation of autonomous vehicles.

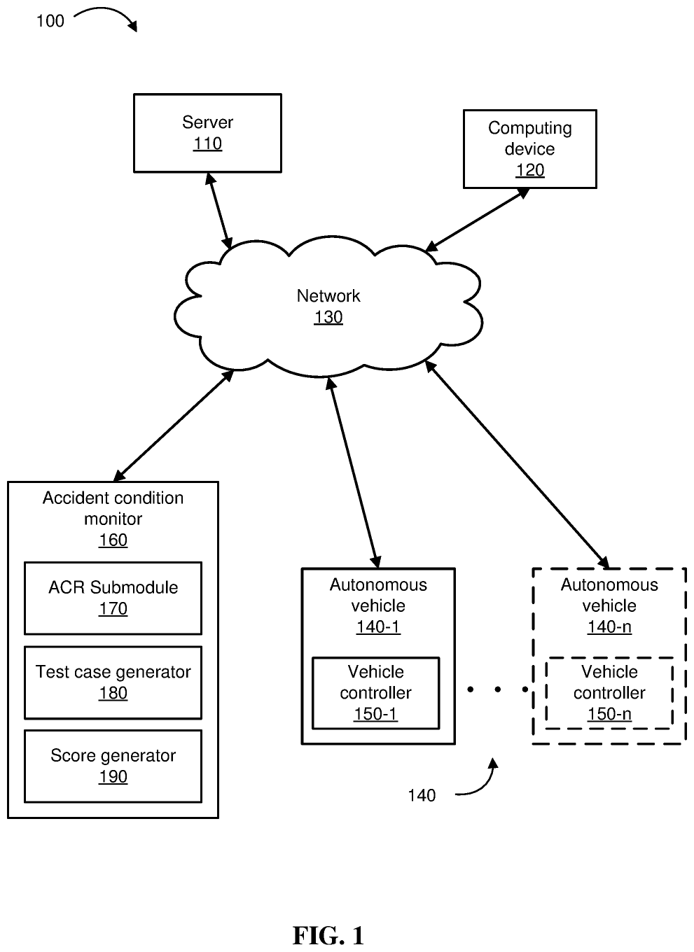

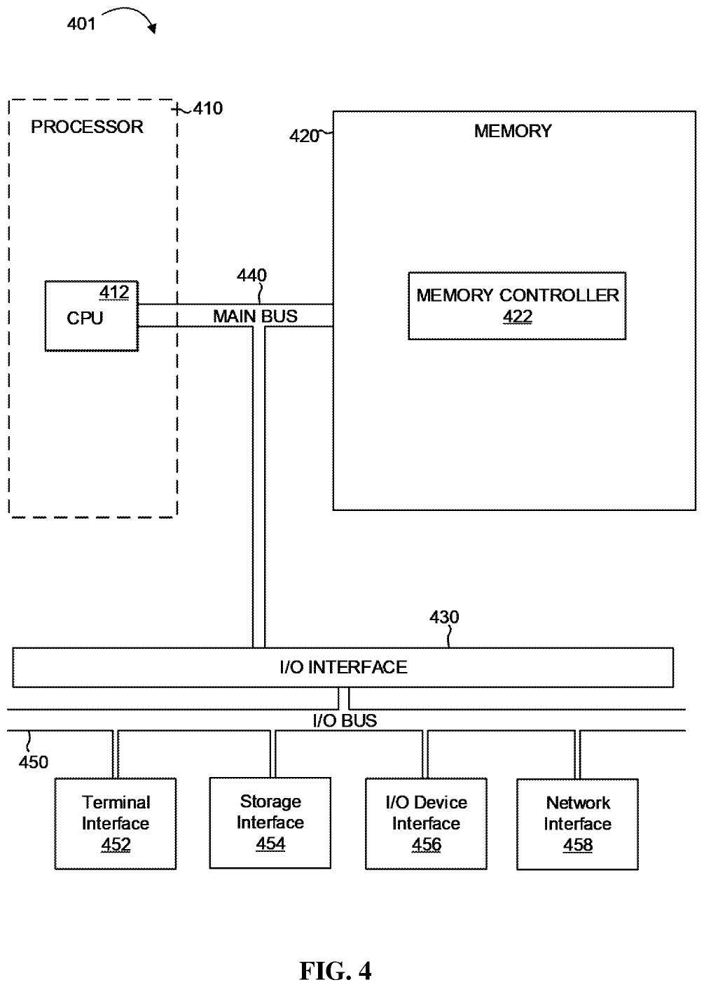

Turning to the figures, FIG. 1 illustrates an example computing environment 100 that includes a set of autonomous vehicles 140, a server 110, a computing device 120, and an accident condition monitor 160 that can exchange data with each other through a network 130. In some embodiments, the example computing environment 100 can include one or more of each of a server 110, a computing device 120, a network 130, and an accident condition monitor 160. The set of autonomous vehicles 140 can include one or more autonomous vehicles. For example, in some embodiments, the set of autonomous vehicles 140 can include n autonomous vehicles, where n is an integer greater than zero. For example, n=1 in embodiments in which the set of autonomous vehicles 140 includes only a first autonomous vehicle 140-1 having a first vehicle controller 150-1; n=2 in embodiments in which the set of autonomous vehicles 140 includes two autonomous vehicles (a first autonomous vehicle 140-1 having a first vehicle controller 150-1 and a second autonomous vehicle 140-2 having a second vehicle controller 150-2); and so on. In some embodiments, one or more of the server 110, the computing device 120, the network 130, the set of autonomous vehicles 140, each vehicle controller 150-n, and the accident condition monitor 160 can include a computer system, such as the computer system 401 described with respect to FIG. 4.

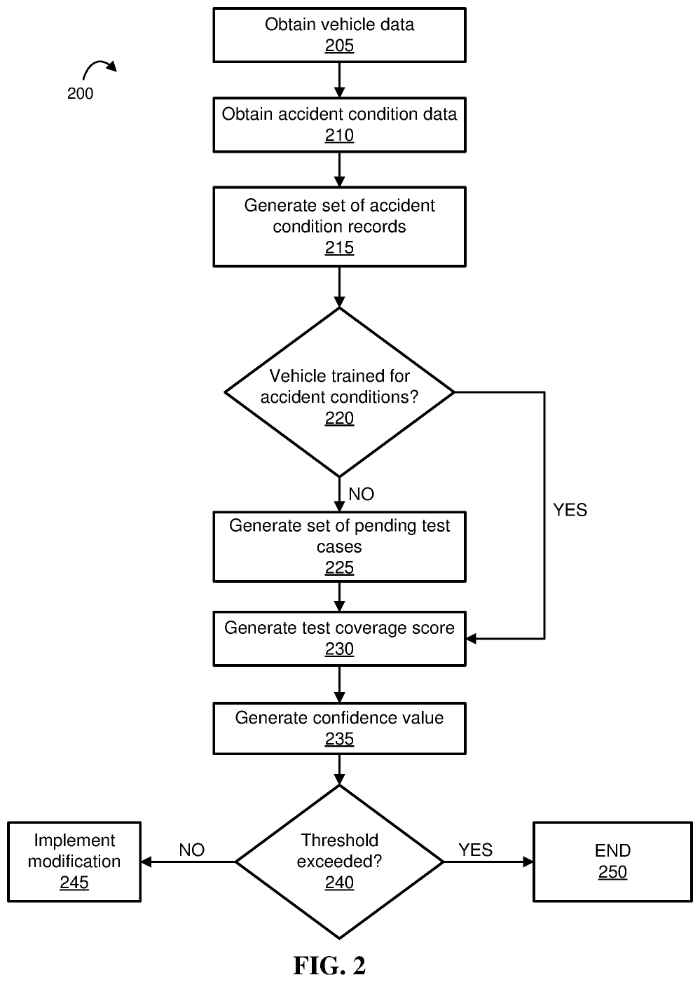

Referring back to FIG. 1, in some embodiments, each autonomous vehicle 140-n can include a vehicle controller 150-n that is configured to control a set of driving maneuvers (e.g., steering, braking, accelerating, etc.) of the autonomous vehicle 140-n and/or to determine a state of operation of the autonomous vehicle 140-n (e.g., determining to maintain control of the autonomous vehicle or determining to relinquish control of the autonomous vehicle). In some embodiments, each vehicle controller 150-n can perform one or more of the method steps described with respect to FIG. 2. For example, in some embodiments, a vehicle controller 150-n can determine a confidence value based, at least in part, on a test coverage score; determine whether a confidence value threshold has been exceeded; and/or implement a modification to the autonomous vehicle 140-n.

Referring back to FIG. 1, in some embodiments, the accident condition monitor 160 can be located remotely from the server 110, the computing device 120, and the set of autonomous vehicles 140. In such embodiments, the accident condition monitor 160 can be integrated into a discrete computer system, such as the computer system 401 described with respect to FIG. 4. In some embodiments, the accident condition monitor 160 can be integrated into the server 110 and/or into an autonomous vehicle 140-n (e.g., within a vehicle controller 150-n). In some embodiments, the accident condition monitor 160 can include an accident condition record submodule (“ACR submodule”) 170, test case generator 180, and score generator 190 integrated into a single device, such as a processor of the accident condition monitor 160. In some embodiments, the accident condition monitor 160 can include a discrete ACR submodule 170, a discrete test case generator 180, and a discrete score generator 190. In some embodiments, components of the accident condition monitor 160 can be located remotely from one another. For example, in some embodiments, the ACR submodule 170 can be integrated into a server 110, and both the test case generator 180 and the score generator 190 can be integrated into a vehicle controller 150-n.

Each of the ACR submodule 170, the test case generator 180, and the score generator 190 can perform one or more of the method steps described with respect to FIG. 2. For example, in some embodiments, the ACR submodule 170 can obtain accident condition data from a server 110 and/or a computing device 120 and generate one or more accident condition records. Continuing with this example, the test case generator 180 can obtain one or more accident condition records, determine whether one or more accident conditions are included in a test case database, and generate one or more pending test cases. Further in this example, the score generator 190 can generate a test coverage score, transmit the test coverage score to a vehicle controller 150-n, and/or generate a calculated confidence value.

In some embodiments, the server 110 can be located remotely from the computing device 120, the set of autonomous vehicles 140, and the accident condition monitor 160. The server 110 can be configured to obtain, store, and/or transmit data such as accident condition data, vehicle data, accident condition records, and/or test cases.

In some embodiments, the computing device 120 can be located remotely from the server 110, the set of autonomous vehicles 140, and the accident condition monitor 160. In some embodiments, the computing device 120 can include a device such as a web server (e.g., a server storing news articles for a news website, social media posts for a social media website, etc.) or a personal computer. The computing device 120 can be configured to obtain, store, and/or transmit data such as accident condition data, vehicle data, accident condition records, and/or test cases.

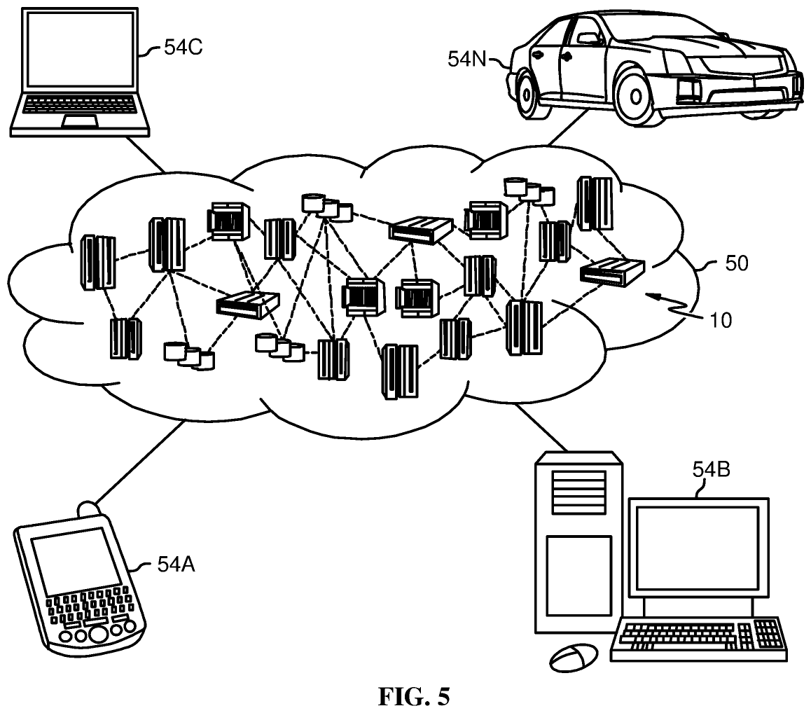

In some embodiments, the network 130 can be a wide area network (WAN), the Internet, or an intranet. In some embodiments, the network 130 can be substantially similar to, or the same as, cloud computing environment 50 described in FIG. 5.

An example configuration of the computing environment 100 can include one or more processors of the server 110 programmed to include the accident condition monitor 160. In this example, the accident condition monitor 160 can obtain accident condition data from the set of autonomous vehicles 140 and/or from one or more computing devices 120. Further in this example, the accident condition monitor 160 can determine one or more test coverage scores that correspond to each autonomous vehicle 140-n of the set of autonomous vehicles 140.

Another example configuration of the computing environment 100 can include one or more processors of a vehicle controller 150-n programmed to include the accident condition monitor 160. In this example, the accident condition monitor 160 can obtain accident condition data from one or more autonomous vehicles 140-n of the set of autonomous vehicles 140, from the server 110, and/or from one or more computing devices 120. Further in this example, the accident condition monitor can determine one or more test coverage scores that correspond to its respective autonomous vehicle 140-n (e.g., a vehicle controller 150-1 programmed to include an accident condition monitor 160 can determine one or more test coverage scores that correspond to autonomous vehicle 140-1).

FIG. 2 illustrates a flowchart of an example method 200 for generating a set of pending test cases and a test coverage score, in accordance with embodiments of the present disclosure. The method 200 can be performed by an accident condition monitor, such as the accident condition monitor 160 described with respect to FIG. 1.

Referring back to FIG. 2, in step 205, the accident condition monitor can obtain vehicle data. Vehicle data can include information corresponding to a user autonomous vehicle (e.g., autonomous vehicle 140-1 described with respect to FIG. 1). For example, in some embodiments, vehicle data can include information such as a location of the user autonomous vehicle, a set of test cases and/or a set of pending test cases of the user autonomous vehicle, a driving route of the user autonomous vehicle, and/or a set of driving conditions that correspond to a driving route of the user autonomous vehicle. The accident condition monitor can obtain such vehicle data from one or more sources such as a global positioning system (“GPS”) included with the user autonomous vehicle and configured to transmit the location of the user autonomous vehicle, a navigation system included with the user autonomous vehicle and configured to transmit a driving route of the user autonomous vehicle, and an electronic storage location (e.g., memory, such as semiconductor memory, of a computer system of a vehicle controller, server, or computing device) configured to store and/or transmit test case data and/or driving condition data. In some embodiments, the accident condition monitor can obtain such vehicle data in real time. By obtaining vehicle data, embodiments of the accident condition monitor can generate and determine data (discussed in further detail below) that is specific to a user autonomous vehicle and its current driving route and driving conditions.

In step 210, the accident condition monitor can obtain accident condition data that can be based, at least in part, on vehicle data obtained in step 205. Accident condition data can include information corresponding to a vehicle accident. In some embodiments, a vehicle accident can include a collision between a vehicle and an animal, another vehicle, a pedestrian, or a structure (e.g., a roadway median wall or guard rail). In some embodiments, a vehicle accident can further include a vehicle that is rendered inoperable due to environmental conditions (e.g., a vehicle that is unable to traverse water, ice, mud and/or snow that has accumulated on a roadway). In some embodiments, the accident condition monitor can obtain such accident condition data via communication with one or more sources such as one or more web servers. The one or more web servers can be configured to store and transmit information such as news articles, social media data, weather data, etc.

In some embodiments, the accident condition monitor can obtain accident condition data from an autonomous vehicle that is involved in a vehicle accident. For example, a first autonomous vehicle driving along a curvy road where freezing conditions are present can collide with a guard rail. In this example, the first autonomous vehicle can be configured to measure, store, and transmit an array of parameters (e.g., ambient temperature, humidity, road curvature, etc.) using temperature sensors, humidity sensors, and cameras. Further in this example, the accident condition monitor can obtain a notification of the first autonomous vehicle's collision from one or more sources (e.g., a communication from the first autonomous vehicle to the accident condition monitor, a radio broadcast describing the collision and its location, and/or a website that publishes an accident report of the collision). Continuing with this example, an accident condition monitor can detect, using GPS data of a second autonomous vehicle, that the curvy road is along the driving route of the second autonomous vehicle. Continuing with this example, the accident condition monitor can obtain, via network communication, accident condition data (e.g., ambient temperature, humidity, and/or road curvature) from the first autonomous vehicle. Further in this example, the accident condition monitor can use the accident condition data from the first autonomous vehicle in association with the second autonomous vehicle, as discussed in the steps below.

The accident condition monitor can be configured to utilize structured data and/or unstructured data. In some embodiments, structured data can include information having a defined form, such as data elements that are arranged within rows and columns of a table or database. In some embodiments, unstructured data can include information that may not have a predefined form. For example, unstructured data can include images (e.g., photographs, videos, etc.), text compositions (e.g., news articles, accident reports, messages posted on social media, etc.), and audible information (e.g., radio broadcasts). To utilize unstructured data, embodiments of the accident condition monitor can include natural language processing technology as well as image and audio analysis technology.

By obtaining accident condition data, embodiments of the accident condition monitor can address driving conditions under which one or more vehicle accidents have occurred; thus, embodiments of the present disclosure can address driving conditions that can be particularly hazardous for a user autonomous vehicle.

In step 215, the accident condition monitor can generate a set of accident condition records. An accident condition record can include one or more characteristics that correspond to a vehicle accident. Such characteristics can include aspects such as traffic density, pedestrian density, road conditions (e.g., wet or icy roads), weather (e.g., fog, precipitation, wind speed and direction, etc.), road characteristics (e.g., road curvature, road slope, road construction status, road surface information, such as whether a road is paved, bumpy, gravelly, etc.). In some embodiments, the accident condition monitor can generate the set of accident condition records based, at least in part, on structured and/or unstructured accident condition data obtained in step 210. In some embodiments, the accident condition monitor can store the set of accident condition records as structured data, such as in a table or database.

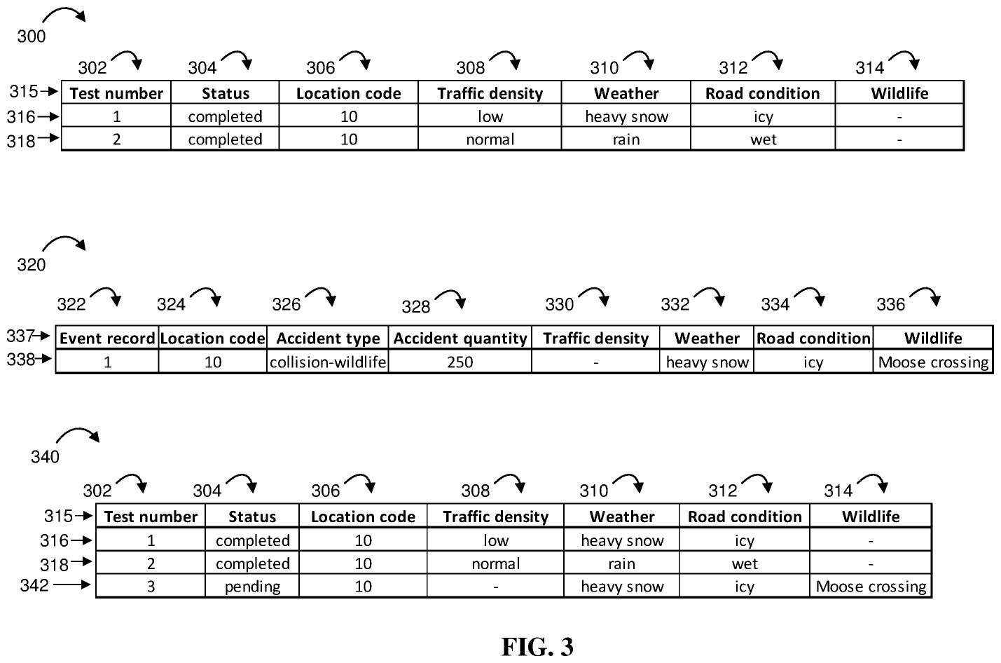

For example, in some embodiments, a traffic news website can publish a report of a multi-vehicle collision. In this example, the accident condition monitor can obtain the report and identify keywords in the report that describe driving conditions (e.g., high traffic, congestion, collision, visibility, heavy rain, etc.) under which the vehicle accident occurred. Further in this example, the accident condition monitor can store such keywords into an accident record table (e.g., accident record table 320 described with respect to FIG. 3 below). Continuing with this example, the accident condition monitor can generate an accident condition record that identifies the location of the accident (e.g., a mile marker or a GPS location) and a set of accident conditions (e.g., driving conditions that correspond to the vehicle accident, such as heavy rain, strong wind, low visibility, highway, dense traffic).

In step 220, the accident condition monitor can determine whether a vehicle controller of an autonomous vehicle has been trained to operate under a set of accident conditions. To make such a determination, in some embodiments, the accident condition monitor can compare a set of accident condition records to test case data of the autonomous vehicle. Test case data can include a set of driving conditions under which a vehicle controller of an autonomous vehicle has been trained. In some embodiments, step 220 can include the accident condition monitor determining whether the test case data of the autonomous vehicle includes a set of accident condition records. For example, in some embodiments, a vehicle controller can be trained to maneuver an autonomous vehicle at night, on a highway, when it is raining. In this example, test case data corresponding to the vehicle can include a table (e.g., table 300 described with respect to FIG. 3 below) that indicates that the vehicle controller has been trained to operate under the set of characteristics: time of day: night; road type: highway; weather: rain. Test case data can also include a set of conditions under which a vehicle controller of an autonomous vehicle has not been trained (such conditions are discussed below with respect to step 225).

An example implementation of steps 205-220 can include the vehicle controller of an autonomous vehicle (discussed above) that is trained to operate at night, on a highway, when it is raining. In this example, the accident condition monitor can obtain the location, driving route, and test case data of the autonomous vehicle via communication with GPS and navigation systems of the autonomous vehicle and with the vehicle controller, which can be configured to store test case data of the autonomous vehicle. Further in this example, the accident condition monitor can obtain accident condition data in the form of an audio broadcast message from a traffic news radio station. Such audio broadcast message can describe a vehicle collision that has occurred 30 miles ahead of the autonomous vehicle, along the driving route of the autonomous vehicle. Further in this example, the accident condition monitor can generate an accident condition record corresponding to the accident condition data by using natural language processing technology to identify and store characteristics that correspond to the vehicle collision. Continuing with this example, based on a natural language processing analysis, the accident condition monitor can identify the following driving conditions that correspond to the vehicle collision: time of day: night; road type: highway; weather: rain, strong winds; road geometry: downhill, 30% grade. Continuing with this example, the accident condition monitor can store such characteristics in a table that represents an accident condition record. Continuing with this example, the accident condition monitor can compare the accident condition record table to the test case data table to determine whether the test case data includes the set of conditions included in the accident condition record (i.e., time of day: night; road type: highway; weather: rain, strong winds; road geometry: downhill, 30% grade). Continuing with this example, the accident condition monitor can determine that the test case data includes only a portion of the set of conditions included in the accident condition record (i.e., the test case data includes time of day: night; road type: highway; weather: rain, but the test case data does not include time of day: night; road type: highway; weather: rain, strong winds; road geometry: downhill, 30% grade). Continuing with this example, the absence of the set of conditions included in the accident condition record from the test case data can indicate that the vehicle controller has not been trained to operate under the conditions: time of day: night; road type: highway; weather: rain, strong winds; road geometry: downhill, 30% grade. Accordingly, in this example, the accident condition monitor can proceed to step 225, described in further detail below.

If the accident condition monitor determines that the vehicle controller has not been trained to operate under a set of accident conditions, then in step 225, the accident condition monitor can generate a set of pending test cases. A pending test case can include a set of driving conditions under which a vehicle controller has not yet been trained; thus, a pending test case can indicate a set of driving conditions under which the vehicle controller can be trained at a future time. In some embodiments, a pending test case can include a set of driving conditions that are added to a record, such as a table or database of test cases.

Continuing with the example discussed above, in step 225, the accident condition monitor can add the conditions: time of day: night; road type: highway; weather: rain, strong winds; road geometry: downhill, 30% grade, to a table or database of test cases. Accordingly, in this example, the accident condition monitor can update test case data corresponding to the autonomous vehicle such that the test case data includes one or more pending test cases. Such pending test cases can be used at a subsequent time to update the training of the vehicle controller. For example, if the autonomous vehicle discussed above undergoes a routine maintenance procedure that includes updating the training of the vehicle controller, a maintenance entity (e.g., a maintenance technician) can train the vehicle controller so that it can be operable to maneuver the autonomous vehicle under the conditions specified in the pending test case (e.g., the vehicle controller can be trained to operate under the conditions: time of day: night; road type: highway; weather: rain, strong winds; road geometry: downhill, 30% grade).

By generating a set of pending test cases, embodiments of the present disclosure can identify, during operation of the autonomous vehicle, a set of driving conditions that can be particularly hazardous to vehicles and that the vehicle controller is not trained to handle. Thus, embodiments of the present disclosure can improve autonomous vehicle training by continuously identifying hazardous driving conditions under which a vehicle controller can benefit from training.

In some embodiments, the method 200 can end with step 225. However, in some embodiments, the accident condition monitor can proceed to step 230 after generating a set of pending test cases in step 225 or after determining in step 220 that a vehicle controller has been trained for a set of accident conditions. In step 230, the accident condition monitor can generate a test coverage score. A test coverage score can correspond to a degree of similarity between an accident condition record and test case data. For example, in some embodiments, the accident condition monitor can generate a test coverage score of 100% when the accident condition monitor determines in step 220 that a vehicle controller has been trained for a set of accident conditions (e.g., test case data corresponding to the vehicle controller includes a set of accident condition records generated in step 215). In contrast, in some embodiments, when the accident condition monitor determines in step 220 that a vehicle controller has not been trained for a set of accident conditions, then the accident condition monitor can calculate a test coverage score by comparing the set of driving conditions present in the accident condition record with a set of driving conditions present in the test case data. Based on such comparison, the accident condition monitor can calculate a test coverage score that corresponds to the degree of difference between the set of driving conditions present in the accident condition record and the set of driving conditions present in the test case data.

For example, continuing with the example discussed above, the accident condition monitor can compare the set of driving conditions present in the accident condition record (i.e., time of day: night; road type: highway; weather: rain, strong winds; road geometry: downhill, 30% grade) with a set of driving conditions present in the test case data (i.e., time of day: night; road type: highway; weather: rain). In this example, the accident condition monitor can identify that three driving conditions (i.e., weather: strong winds; road geometry: downhill, 30% grade) are not present in the test case data. Continuing with this example, the accident condition monitor can calculate a test coverage score of 50%, based on the test case data including three of the six (i.e., 50%) of the driving conditions present in the accident condition record. In some embodiments, step 230 can include weighting driving conditions such that certain predetermined driving conditions can have a greater effect on the test coverage score generated by the accident condition monitor. By weighting driving conditions, the accident condition monitor can account for a degree of hazard associated with each driving condition (e.g., an icy road can be considered more hazardous than a particular road geometry; thus, the icy road can be assigned a higher weight than the particular road geometry).

In some embodiments, step 230 can include the accident condition monitor transmitting the test coverage score to the vehicle controller, and afterward, the method 200 can end. In these embodiments, the vehicle controller can determine whether to implement a modification in a manner similar to steps 235-245 discussed below. In some embodiments, method 200 can proceed to step 235, discussed in further detail below.

In step 235, the accident condition monitor can generate a confidence value. The confidence value can indicate the vehicle controller's preparedness for maneuvering the autonomous vehicle under a set of driving conditions. In some embodiments, the confidence value can be equivalent to the test coverage score generated in step 230. In some embodiments, the confidence value can be based, at least in part, on the test coverage score and on a set of vehicle parameters corresponding to the autonomous vehicle. In some embodiments, such vehicle parameters can include information regarding the operation and/or the specifications of the autonomous vehicle. For example, in some embodiments, the set of vehicle parameters can include historical data, such as database values stored in a memory of the vehicle controller, that indicates the vehicle controller's previous decisions regarding maneuvering (e.g., steering, braking, accelerating, etc.) the autonomous vehicle under a set of driving conditions. In some embodiments, such historical data can include previous states of operation of the autonomous vehicle (e.g., whether the vehicle controller chose to maintain control of the autonomous vehicle or to relinquish control of the autonomous vehicle and/or whether a vehicle operator chose to take manual control of the autonomous vehicle) under a set of driving conditions.

For example, continuing with the example discussed above in which the accident condition monitor generated a test coverage score of 50%, the accident condition monitor, in step 235, can generate a confidence value that is based, at least in part, on the test coverage score. Continuing with this example, the accident condition monitor can determine from vehicle data that includes historical data that the vehicle controller has encountered the conditions, time of day: night; road type: highway; weather: rain, strong winds; road geometry: downhill, 30% grade, on five previous occasions, and on each of those five previous occasions the vehicle controller maintained control of the autonomous vehicle. Continuing with this example, the accident condition monitor can generate a confidence value of 75% by averaging the test coverage score (50%) and the percentage of times (100%) the vehicle controller maintained control of the autonomous vehicle under the driving conditions in question (i.e., time of day: night; road type: highway; weather: rain, strong winds; road geometry: downhill, 30% grade).

In step 240, the accident condition monitor can compare the confidence value generated in step 235 to a predetermined threshold and determine whether the confidence value exceeds the predetermined threshold. For example, an entity, such as a vehicle manufacturer, can select a threshold of 90% that must be exceeded before a vehicle controller is allowed to maintain control of an autonomous vehicle under a given set of driving conditions. Such a threshold can be selected according to a set of established standards for safe operation of autonomous vehicles. If the accident condition monitor determines in step 240 that the confidence value does not exceed the threshold, then the accident condition monitor can proceed to step 245. If the accident condition monitor determines in step 240 that the confidence value does exceed the threshold, then the accident condition monitor can proceed to step 250. Continuing with the example discussed above, the accident condition monitor can determine that the 75% confidence value generated in step 235 does not exceed the 90% threshold; thus, in this example, the accident condition monitor can proceed to step 245.

In step 245, the accident condition monitor can implement a modification. In some embodiments, implementing a modification can include the accident condition monitor transmitting a command to the vehicle controller to take an action. In some embodiments, such an action can include a changing maneuvering (e.g., steering, braking, accelerating, driving route etc.) of the autonomous vehicle. In some embodiments, such an action can include changing a state of operation of the autonomous vehicle (e.g., relinquishing control of the autonomous vehicle).

In step 250, method 200 can end; thus, the accident condition monitor may not implement a modification.

FIG. 3 depicts example tables that can be obtained and/or generated by an accident condition monitor, in accordance with embodiments the present disclosure. The example tables shown in FIG. 3 can be stored in the memory of a computer system, such as the computer system discussed with respect to FIG. 4. For simplicity, the example tables shown in FIG. 3 include fewer than five test cases and event records. However, in some embodiments, the accident condition monitor can generate tables that include far greater numbers (e.g., hundreds of thousands) of test cases and event records. Similarly, for simplicity, the example tables shown in FIG. 3 include a small number (e.g., fewer than 10) of driving conditions. However, in some embodiments, the accident condition monitor can generate tables that include greater numbers (e.g., hundreds) of driving conditions.

In FIG. 3, the test case table 300 includes a first test case 316 and a second test case 318. The first test case 316 and the second test case 318 each include a set of driving conditions under which the vehicle controller has been trained to operate. The test case table 300 includes a row of column headings 315. The test case data table 300 further includes a test number column 302 that includes a numbered list of the test cases. The test case data table 300 further includes a status column 304 that indicates whether a test case has been completed (e.g., the vehicle controller has been trained to operate under the driving conditions of the test case) or whether a test case is pending (e.g., the vehicle controller has not been trained to operate under the driving conditions of the test case). The test case data table 300 further includes a location code column 306 that indicates a geographic location corresponding to the test case (e.g., a city where the autonomous vehicle can encounter the driving conditions included in the test case; here, the location code “10” can represent a geographic region such as, for example, southern Alaska). The test case data table 300 further includes a traffic density column 308 that indicates a quantity of vehicles (e.g., a “low,” “normal,” or “high” designation, based on a number of vehicles per unit mile) corresponding to the test case. The test case data table 300 further includes a weather column 310 that describes precipitation (or other weather-related data such as wind, temperature, visibility, etc.) corresponding to the test case. The test case data table 300 further includes a road condition column 312 that describes a road condition corresponding to the test case. The test case data table 300 further includes a wildlife column 314 that describes wildlife information corresponding to the test case. The test case data table 300 includes a “-” where no relevant information is included.

The accidents condition monitor can generate the accident record table 320 and the updated test case table 340 after obtaining and analyzing data such as, for example, the news article, Watch Out for Moose while Driving in Southern Alaska:

“Southern Alaska has one of the highest rates of moose-vehicle collisions in the northern hemisphere. Each year motorists strike and kill hundreds of Moose on roadways in southern Alaska. While other wildlife-vehicle collisions occur, the number of moose-vehicle collisions is far greater. Most of these accidents occur during the winter months of December, January, and February when roads are icy and visibility is low due to limited lighting and high snowfall. Each year, an average of 250 moose-vehicle collisions occur in the region . . . ”

Since the news article includes unstructured data, in this example, the accident condition monitor can search the news article for predetermined keywords (e.g., collisions, roadways, accidents, snowfall) and/or implement natural language processing technology to identify relevant driving conditions that it can include in accident event record 338 when it generates the accident record table 320. Accident record table 320 further includes a row of column headings 337. Accident record table 320 further includes an event record column 322 that includes a numbered list of the accident event records. Accident record table 320 further includes a location code column 324 that indicates a geographic location corresponding to the identified accident. Accident record table 320 further includes an accident type column 326 that includes a description of the identified accident. Accident record table 320 further includes an accident quantity column 328 that indicates a number of instances of the identified accident. Accident record table 320 further includes a traffic density column 330 that indicates a quantity of vehicles corresponding to the identified accident. Accident record table 320 further includes a weather column 332 that describes precipitation corresponding to the identified accident. Accident record table 320 further includes a road condition column 334 that describes a road condition corresponding to the identified accident. Accident record table 320 further includes a wildlife column 336 that describes wildlife information corresponding to the identified accident. Accident record table includes a “-” where no relevant information is included.

Further in this example, the accident condition monitor can compare the accident record table 320 to the test case data table 300 and identified that the test case data table 300 does not include a test case that includes wildlife. Accordingly, the accident condition monitor can determine that the vehicle controller has not been trained to maneuver the autonomous vehicle under the driving conditions of heavy snow, icy roads, and a risk of collision with moose. In response, the accident condition monitor can generate the updated test case data table 340 that includes a third test case 342.

The updated test case data table 340 is identical to the test case data table 300, except that the updated test case data table 340 includes the third test case 342. Additionally, the status of the third test case 342 is “pending” due to the fact that the vehicle controller has not yet been trained to operate under the conditions specified in the third test case 342. The third test case 342 also specifies a “moose crossing” driving condition so that the vehicle controller can be trained to handle moose crossings in addition to other specified driving conditions (e.g., heavy snow and icy roads). Based on the updated test case data table 340, the vehicle controller can be updated (e.g., by physical training of an autonomous vehicle by a maintenance entity and/or by a computer system software update) such that it can maneuver the autonomous vehicle under the driving conditions included in the third test case 342.

FIG. 4 depicts the representative major components of an exemplary Computer System 401 that can be used in accordance with embodiments of the present disclosure. The particular components depicted are presented for the purpose of example only and are not necessarily the only such variations. The Computer System 401 can comprise a Processor 410, Memory 420, an Input/Output Interface (also referred to herein as I/O or I/O Interface) 430, and a Main Bus 440. The Main Bus 440 can provide communication pathways for the other components of the Computer System 401. In some embodiments, the Main Bus 440 can connect to other components such as a specialized digital signal processor (not depicted).

The Processor 410 of the Computer System 401 can be comprised of one or more CPUs 412. The Processor 410 can additionally be comprised of one or more memory buffers or caches (not depicted) that provide temporary storage of instructions and data for the CPU 412. The CPU 412 can perform instructions on input provided from the caches or from the Memory 420 and output the result to caches or the Memory 420. The CPU 412 can be comprised of one or more circuits configured to perform one or methods consistent with embodiments of the present disclosure. In some embodiments, the Computer System 401 can contain multiple Processors 410 typical of a relatively large system. In other embodiments, however, the Computer System 401 can be a single processor with a singular CPU 412.

The Memory 420 of the Computer System 401 can be comprised of a Memory Controller 422 and one or more memory modules for temporarily or permanently storing data (not depicted). In some embodiments, the Memory 420 can comprise a random-access semiconductor memory, storage device, or storage medium (either volatile or non-volatile) for storing data and programs. The Memory Controller 422 can communicate with the Processor 410, facilitating storage and retrieval of information in the memory modules. The Memory Controller 422 can communicate with the I/O Interface 430, facilitating storage and retrieval of input or output in the memory modules. In some embodiments, the memory modules can be dual in-line memory modules.

The I/O Interface 430 can comprise an I/O Bus 450, a Terminal Interface 452, a Storage Interface 454, an I/O Device Interface 456, and a Network Interface 458. The I/O Interface 430 can connect the Main Bus 440 to the I/O Bus 450. The I/O Interface 430 can direct instructions and data from the Processor 410 and Memory 420 to the various interfaces of the I/O Bus 450. The I/O Interface 430 can also direct instructions and data from the various interfaces of the I/O Bus 450 to the Processor 410 and Memory 420. The various interfaces can comprise the Terminal Interface 452, the Storage Interface 454, the I/O Device Interface 456, and the Network Interface 458. In some embodiments, the various interfaces can comprise a subset of the aforementioned interfaces (e.g., an embedded computer system in an industrial application may not include the Terminal Interface 452 and the Storage Interface 454).

Logic modules throughout the Computer System 401—including but not limited to the Memory 420, the Processor 410, and the I/O Interface 430—can communicate failures and changes to one or more components to a hypervisor or operating system (not depicted). The hypervisor or the operating system can allocate the various resources available in the Computer System 401 and track the location of data in Memory 420 and of processes assigned to various CPUs 412. In embodiments that combine or rearrange elements, aspects of the logic modules' capabilities can be combined or redistributed. These variations would be apparent to one skilled in the art.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 5, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N can communicate. Nodes 10 can communicate with one another. They can be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

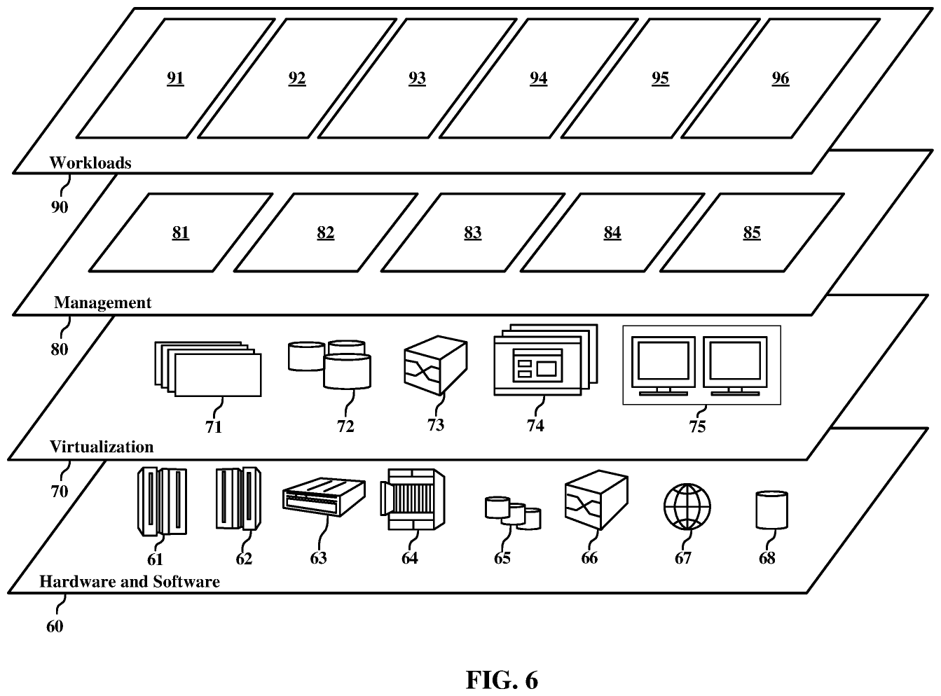

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities can be provided: virtual servers 71; virtual storage 72; virtual networks 73, including virtual private networks; virtual applications and operating systems 74; and virtual clients 75.

In one example, management layer 80 can provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources can comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment can be utilized. Examples of workloads and functions which can be provided from this layer include: mapping and navigation 91; software development and lifecycle management 92; virtual classroom education delivery 93; data analytics processing 94; transaction processing 95; and accident condition monitoring logic 96.

As discussed in more detail herein, it is contemplated that some or all of the operations of some of the embodiments of methods described herein can be performed in alternative orders or may not be performed at all; furthermore, multiple operations can occur at the same time or as an internal part of a larger process.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method comprising:
obtaining vehicle data corresponding to an autonomous vehicle,
wherein the autonomous vehicle includes a vehicle controller configured to control a set of driving maneuvers of the autonomous vehicle;
obtaining accident condition data based, at least in part, on the vehicle data,
wherein the accident condition data includes a first set of driving conditions under which a vehicle accident occurred;
generating an accident condition record based, at least in part, on the accident condition data;
determining that the vehicle controller is not trained to control the set of driving maneuvers of the autonomous vehicle under the first set of driving conditions; and
generating, in response to the determining, a pending test case based, at least in part, on the accident condition record.

2. The computer-implemented method of claim 1, further comprising:
generating a test coverage score that corresponds to a degree of similarity between the accident condition record and test case data,
wherein the test case data comprises a second set of driving conditions under which the vehicle controller is trained.

3. The computer-implemented method of claim 2, further comprising:
generating a confidence value based, at least in part, on the test coverage score,
wherein the confidence value indicates an extent to which the vehicle controller is trained to control the set of driving maneuvers of the autonomous vehicle under the first set of driving conditions.

4. The computer-implemented method of claim 3, further comprising:
comparing the confidence value to a threshold; and
in response to determining that the threshold is not exceeded, implementing a modification to the autonomous vehicle.

5. The computer-implemented method of claim 1, wherein the accident condition data comprises unstructured data; and
wherein generating the accident condition record further comprises identifying one or more keywords within the unstructured data and including the one or more keywords in the accident condition record.

6. The computer-implemented method of claim 1, wherein the accident condition data includes a driving route of the autonomous vehicle; and
the accident condition data corresponds to a vehicle accident on the driving route.

7. The computer-implemented method of claim 3, wherein the confidence value is equivalent to the test coverage score.

8. A system comprising:
a processor; and
a memory in communication with the processor, the memory containing program instructions that, when executed by the processor, are configured to cause the processor to perform a method, the method comprising:
obtaining vehicle data corresponding to an autonomous vehicle,
wherein the autonomous vehicle includes a vehicle controller configured to control a set of driving maneuvers of the autonomous vehicle;
obtaining accident condition data based, at least in part, on the vehicle data,
wherein the accident condition data includes a first set of driving conditions under which a vehicle accident occurred;
generating an accident condition record based, at least in part, on the accident condition data;
determining that the vehicle controller is not trained to control the set of driving maneuvers of the autonomous vehicle under the first set of driving conditions; and
generating, in response to the determining, a pending test case based, at least in part, on the accident condition record.

9. The system of claim 8, further comprising:
generating a test coverage score that corresponds to a degree of similarity between the accident condition record and test case data,
wherein the test case data comprises a second set of driving conditions under which the vehicle controller is trained.

10. The system of claim 9, further comprising:
generating a confidence value based, at least in part, on the test coverage score,
wherein the confidence value indicates an extent to which the vehicle controller is trained to control the set of driving maneuvers of the autonomous vehicle under the first set of driving conditions.

11. The system of claim 10, further comprising:
comparing the confidence value to a threshold; and
in response to determining that the threshold is not exceeded, implementing a modification to the autonomous vehicle.

12. The system of claim 8, wherein the accident condition data comprises unstructured data; and
wherein generating the accident condition record further comprises identifying one or more keywords within the unstructured data and including the one or more keywords in the accident condition record.

13. The system of claim 8, wherein the accident condition data includes a driving route of the autonomous vehicle; and
the accident condition data corresponds to a vehicle accident on the driving route.

14. The system of claim 10, wherein the confidence value is equivalent to the test coverage score.

15. A computer program product comprising a computer readable storage medium having program instructions embodied therewith, wherein the computer readable storage medium is not a transitory signal per se, the program instructions executable by a processor to cause the processor to perform a method, the method comprising:
obtaining vehicle data corresponding to an autonomous vehicle,
wherein the autonomous vehicle includes a vehicle controller configured to control a set of driving maneuvers of the autonomous vehicle;
obtaining accident condition data based, at least in part, on the vehicle data,
wherein the accident condition data includes a first set of driving conditions under which a vehicle accident occurred;
generating an accident condition record based, at least in part, on the accident condition data;
determining that the vehicle controller is not trained to control the set of driving maneuvers of the autonomous vehicle under the first set of driving conditions; and
generating, in response to the determining, a pending test case based, at least in part, on the accident condition record.

16. The computer program product of claim 15, further comprising:
generating a test coverage score that corresponds to a degree of similarity between the accident condition record and test case data,
wherein the test case data comprises a second set of driving conditions under which the vehicle controller is trained.

17. The computer program product of claim 16, further comprising:
generating a confidence value based, at least in part, on the test coverage score,
wherein the confidence value indicates an extent to which the vehicle controller is trained to control the set of driving maneuvers of the autonomous vehicle under the first set of driving conditions.

18. The computer program product of claim 17, further comprising:
comparing the confidence value to a threshold; and
in response to determining that the threshold is not exceeded, implementing a modification to the autonomous vehicle.

19. The computer program product of claim 15, wherein the accident condition data comprises unstructured data; and
wherein generating the accident condition record further comprises identifying one or more keywords within the unstructured data and including the one or more keywords in the accident condition record.

20. The computer program product of claim 15, wherein the accident condition data includes a driving route of the autonomous vehicle; and
the accident condition data corresponds to a vehicle accident on the driving route.
